(19) United States
(12) Patent Application Publication
(10) Pub. No.: US 2007/0050356 A1
(43) Pub. Date: Mar. 1, 2007

(54) Query construction for semantic topic indexes derived by non-negative matrix factorization

(76) Inventor: William J. Amadio, Lawrenceville, NJ (US)

Correspondence Address: NATH & ASSOCIATES PLLC, 112 South West Street, Alexandria, VA, 22314, US

(21) Appl. No.: 11/507,661

(22) Filed: Aug. 22, 2006

Related U.S. Application Data
(60) Provisional application No. 60/710,150, filed on Aug. 23, 2005.

(51) Int. Cl. G06F 17/30

(52) U.S. Cl. 707/5

(57) ABSTRACT

A method, apparatus and machine-readable medium analyze documents processed by non-negative matrix factorization in accordance with semantic topics. Users construct queries by assigning weights to semantic topics to order documents within a set. The query may be refined in accordance with the user's evaluation of the efficacy of the query. Any document that does not result in data indicative of significant correlation with at least one semantic topic is flagged so that a user may make a manual review. The collection of semantic topics may be continually or periodically updated in response to new documents. Additionally, the collection may also be “downdated” to drop semantic factors no longer appearing in new documents received after an initial set has been analyzed. Different sets of semantic topics may be generated and each document evaluated using each set. Reports may be prepared showing results for a body of documents for each of a plurality of sets of semantic topics.

### FIELD OF THE INVENTION

The present subject matter relates to providing a data structure and method through which content may be efficiently analyzed to make content of interest readily accessible.

### BACKGROUND OF THE INVENTION

Making determinations with respect to elements of content is a significant application. Content may comprise words or other discernible intelligence within a body of documents or other compilations of intelligence. Various terms are used for various forms of finding particular content within fields of content. One term is data mining. Another form of searching is information retrieval, often referred to by the abbreviation IR. A significant IR task is the analysis of unprocessed communications. Such communications could comprise letters to the editor of a publication or communications intercepted by an intelligence agency. The user may not have foreknowledge of the contents of the communications. Since the user does not know what search terms may be in the documents, creating queries would require guessing as to what search terms might be found in the documents. Semantic indexing allows a user to explore what an analysis program has found in a document.

Traditional methods for information retrieval are based on an associative model of recognizing meaning in text. Associative models identify concepts by measuring how often particular terms occur in a specific document compared to how often they occur in general. In practice, this typically means that such systems record the content of a document by recognizing which words appear within the document along with their frequency. Essentially, a standard information retrieval system will count how often each word, or other resolvable unit of intelligence, occurs in a particular document. This information is then saved in a matrix, or table, indexed by the word and document name. In a typical keyword-based information retrieval system, a table would contain a column for each document in a searchable database, and a row for every word. Since the number of words in a given language, e.g., English, is large, many information retrieval systems reduce the number of distinct words they recognize by removing common prefixes and suffixes from words. For example, the words “engine,” “engineer,” “reengineer” and “engineering” may be “stemmed,” or truncated, as instances of “engine” to save space. In addition, many information retrieval systems ignore commonly occurring words like “the” “an” “is” and “have.” Because these words appear so often in English, they are assumed to carry little distinguishing value for the IR task, and eliminating them from the index reduces the size of that index. Such words are referred to as stop words.

Keyword-based information retrieval is accomplished in response to queries. A user must be sure to enter the appropriate keyword in each query, or the IR system may miss relevant documents. For example, a user searching for information on airplanes may find that searching on the term “plane” or “Boeing 727” will retrieve documents that would not be found by using the term “airplane” alone. A searcher must find an exact “hit” rather than one of a related group of words. Although some IR systems now use thesauri to automatically expand a search by adding synonymous terms, it is unlikely that a thesaurus can provide all possible synonymous terms. This lack of rigor is referred to as a lack of recall because the system has failed to recall (or find) all documents relevant to a query. There is a clear need for a rapid and efficient search mechanism that will permit searching of natural language documents.

One prior art approach is disclosed in U.S. Pat. No. 6,741,988. A relational text index creation and search technique is provided using algorithms, methods, techniques and tools designed for information extraction to create and search indexes. Four important processes performed in some embodiments of the inventions are parsing, caseframe application, theta role assignment and unification. Parsing involves diagramming natural language sentences. Caseframe application involves applying structures called caseframes that perform the task of information extraction, i.e. they identify specific elements of a sentence that are of particular interest to a user. Theta role assignment translates the raw caseframe-extracted elements to specific thematic or conceptual roles. Unification collects related theta role assignments together to present a single, more complete representation of an event or relationship. This technique provides analysis of natural language text, but is quite complex.

One form of IR utilizes non-negative matrix factorization. Non-negative matrix factorization and algorithms to perform non-negative matrix factorization are described in, D. D. Lee and H. S. Seung, Learning the Parts of Objects by Non-negative Matrix Factorization. Nature, 401:788, October 1999. Lee and Seung's technique is able to learn parts of faces and semantic features of text. Such algorithms are further discussed in D. D. Lee and H. S. Seung, Algorithms for Non-negative Matrix Factorization in Adv. in Neural Inform. Proc. Systems, volume 13, 2001. As taught by Michael W. Berry, Murray Browne, Understanding Search Engines: Mathematical Modeling and Text Retrieval, SIAM Society for Industrial & Applied Mathematics; Philadelphia, 1999, a value of an entry in a matrix may be based on either the number of occurrences of a term in a document or on a function of the number of occurrences. Use of non-negative matrix factorization is further discussed in, F. Shahnaz, M. W. Berry, V. P. Pauca, R. J. Plemmons, Document Clustering Using Nonnegative Matrix Factorization, preprint August 2004 at www.cs.wtfu.edu/˜pauca/papers/final_sbppAug04.pdf. Each of these publications is incorporated herein by reference.

An example of prior art IR using non-negative matrix factorization is disclosed in United States Patent Application Publication No. 2003/0018604. A method of indexing a database of documents is disclosed. This application states that most high-precision IR systems utilize a multi-pass strategy. Firstly, initial relevance scoring is performed using the original query, and a list of hits is returned, each with a relevance score. Secondly, a second scoring pass is made, using the information found in the high scoring documents. The indexes for the two relevancy passes described above are usually different. The first relevancy pass usually uses what is known as an inverted index, meaning that a given term is associated with a list of documents containing the term. In the second index, a given document is associated with a list of terms appearing in it. The result is that a two-pass system consumes roughly double the storage media space of a one-pass system. A database is produced comprising a vocabulary of n terms indexed in the form of a non-negative n*m index matrix V, wherein m is equal to the number of documents in the database, n is equal to the number of terms used to represent the database. The value of each element vᵢⱼ of index matrix V is a function of the number of occurrences of the i^{th} vocabulary term in the j^{th} document; factoring out non-negative matrix factors T and D such that V≈TD; and wherein T is an n×r term matrix, D is an r×m document matrix, and r<nm/(n+m). The application states that the values in the term matrix T are not needed for this method. A form of retrieval performance of a two-pass system is provided while requiring only the memory capabilities of a one-pass system. Consequently, less storage media space is consumed. However, this technique of saving space involves discarding information in a dimension of the matrix that would yield scoring information with respect to the prevalence of detected words. The ability to weight relative significance of terms is lost.

These prior art techniques focus on the use of key words. They do not use semantic indexing. With semantic indexing, a document containing only the word “explosive” would be caught by a query on the word “bomb” if some documents in the body contained both the word “bomb” and “explosive.” Semantic indexing is more robust than keyword indexing. An example of the use of semantic indexing is found in U.S. Pat. No. 6,615,208. The technique disclosed therein is not suited for rapid processing of incoming documents.

Documents that have been indexed must be queried in order for a user to derive information. While semantic indexing has provided a powerful tool for indexing, traditional querying techniques have been used to access information from indexed documents. Conventional querying techniques leave untapped many benefits that can be obtained from semantic indexing.

### SUMMARY OF THE INVENTION

Briefly stated, in accordance with embodiments of the present invention a method, system and machine-readable medium are provided suitable for processing bodies of documents or other compilations of intelligence and accessing concepts of interest. For convenience in description, each item being indexed is referred to as a document irrespective of its physical form or electronic format. The documents are first explored and summarized. In one form, unread and unprocessed documents are parsed into a term-document matrix A of values aᵢⱼ, where aᵢⱼ=a function of the number of times the term I appears in document j. The matrix A is factored into a product W*H of two reduced-dimensional matrices W and H using non-negative matrix factorization. H and W are constrained to be non-negative. W represents the semantic topics contained in the body of documents. Each column of W is a basis vector, i.e., it contains an encoding of a semantic space or concept from A. Each column of H contains an encoding of the linear combination of the basis vectors that approximates the corresponding column of A. Users construct a query by assigning weights to semantic topics within W. A user is provided with data responsive to the query, the data being indicative of a value obtained by evaluating the body of documents or newly arrived documents against the query. Each user may in turn provide input information used to refine values in the query in accordance with the user's evaluation of the efficacy of the evaluation against the query. Any document that does not result in data indicative of significant similarity with any semantic topic in W is flagged so that a user may make a manual review. W may be continually or periodically updated in response to new documents. Additionally, W may also be “downdated.” Semantic factors may be dropped if they are no longer appearing in new documents. Different sets of W may be generated and each document evaluated using each W. Reports may be prepared showing one user's results for a document for each of a plurality of W matrices.

In another embodiment of the invention, a machine-readable medium is provided to command performance to analyze the documents. The present invention also comprises a machine-readable medium as a method. A machine-readable medium includes any mechanism that provides (i.e., stores and/or transmits information in a form readable by a machine (e.g., a computer). For example, a machine-readable medium includes read only memory (ROM); random access memory (RAM); magnetic disk storage media; optical storage medial; flash memory devices; electrical, optical, acoustical or other form of propagated signals (e.g., carrier waves, infrared signals, digital signals, etc.) and the like.

### BRIEF DESCRIPTION OF THE DRAWINGS

FIG. 1 is a diagrammatic representation of physical handling of documents;

FIG. 2 is a flow chart illustrating one method of performing an embodiment of the present invention;

FIG. 3 is a diagram illustrating an instance of non-negative matrix factorization; and

FIG. 4 is a chart illustrating a query.

### DETAILED DESCRIPTION

Utilizing embodiments of the present invention, an intelligence agency or other organization, for example, can quickly reduce its backlog of unprocessed documents (i.e. intelligence-bearing items in any discernible form whether in tangible or electronic or other form) and maintain zero backlog by routing freshly accessed documents to appropriate users. Alternatively, an existing database of documents could be analyzed. The procedure utilizes the techniques of semantic indexing, query matching, and factor updating. Semantic indexing reduces a body of thousands of documents to a few hundred groups of resolved terms. In most contemplated applications, the resolved terms will be words. The use of the term “words” below does not exclude the analysis of other types of resolved terms. A user can select resolved terms to create semantic topics. A semantic topic relates a resolved term to a particular topic without requiring an exact word match in the document to a topic of interest. Significance of resolved terms can also be weighted. Different sets of analytical criteria may be established for one set of documents. Analyses against each set of criteria may be provided. Sets of documents may be updated or “downdated” to add or remove documents from the body.

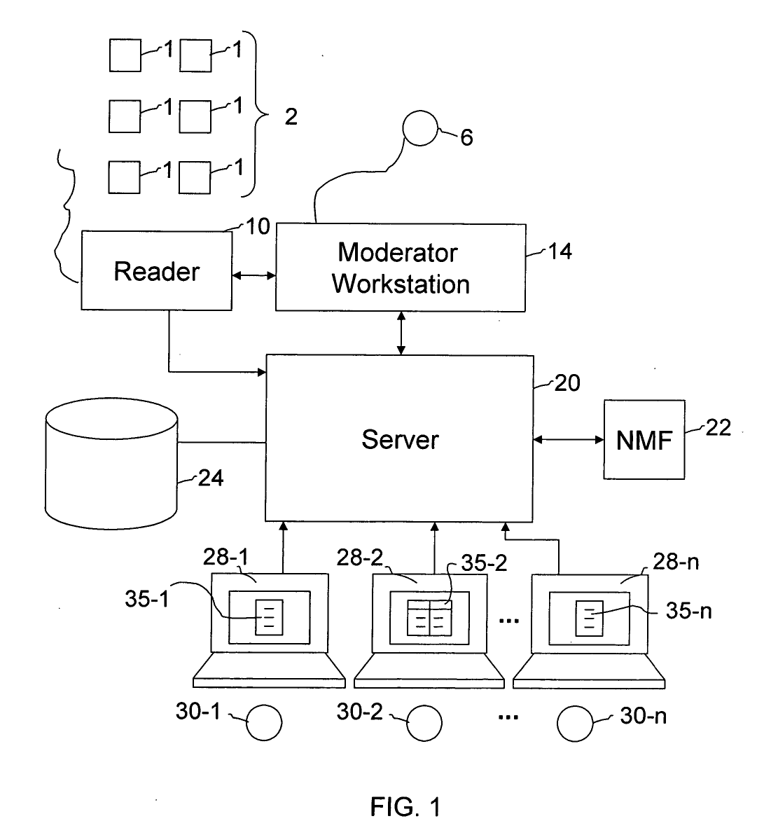

FIG. 1 illustrates physical handling of documents 1. The particular architecture illustrated in FIG. 1 is arbitrary. Many different well-known forms of physical structures may be used to provide the desired operation. A document 1 for purposes of the present description is an intelligence-bearing item. While documents 1 will generally have the attributes of traditional paper or electronic documents, this is not a necessity.

Documents 1 are provided for reading and analysis. Generally, a moderator 6, which may be an individual operator or a programmed, automated unit, controls flow of documents 1 to a reader 10. The moderator 6 may physically handle documents 1 to create sets 2 of documents 1. Alternatively, the moderator 6 may communicate via a workstation 14 to a server 20 to create sets 2. Sets 2 may also or alternatively be created after individual electronic impressions of the documents 1 are stored. Sets 2 may be grouped according to one or more parameters, such as date, source, urgency of processing or by other parameters. Additionally, further sets 2 may be created after analysis of documents 1 based on their content.

Documents 1 are read by the reader 10. Where documents 1 are paper documents, the reader 10 may comprise an optical scanner with optical character recognition (OCR). Electronic documents may be monitored by translation to signals readable by software in the reader 10 or otherwise.

Electronic versions of documents 1 are directed via the server 20. The server 20 may send documents 1 to a processor 22 for non-negative matrix factorization. The results may be delivered from the processor 22 via the server 20 to a database 24. Alternatively, the electronic translations of the documents 1 may be delivered first to the database 24 and accessed by the processor 22 later.

Once non-negative matrix factorization is performed, a W*H matrix, further described below, is produced. W is a matrix whose columns comprise semantic topics. A semantic topic is a group of words that relates terms to a topic of interest. It should be noted that if desired, a semantic topic consisting of only one word could be constructed. Semantic topics are established by selected system users so that individual resolved terms can be related to their meaning. Embodiments of the present invention use semantic topics as a filter on resolved terms to recast the hits in a set in terms of semantic topics rather than individual words. Groups of words within a semantic topic are defined so that, for example, two documents 1 in a set 2 that may have different but related terminology will be both registered as two “hits” in one semantic topic rather than one hit in each of two word classifications. One semantic topic could include words such as streetcar, tram and trolley. Another semantic topic could include explosive and bomb.

Semantic indexing reduces a body of thousands of documents to a few hundred groups of words. Once a set of documents has been resolved into semantic groups, their contents in terms of semantic groups may be examined. A user 30 may visually inspect semantic groups to reveal the nature of a body of documents. A user 30 may base selection of order in which to read documents in accordance with the importance of each semantic topic to the user. Documents 1 in a set 2 that do not have any hits within a defined semantic topic may be analyzed manually. Such documents may contain information relevant to existing semantic topics expressed in unusual ways or may contain material that users may wish to organize into new semantic topics.

In accordance with further aspects of the present invention, semantic topics may be weighted, evaluated and/or further refined. A plurality of users 30-1 to 30-n may each work at a workstation 28-1 to 28-n. Users may alternatively interface with the intelligence contained in the documents 1 in any of a myriad of well-known ways. As illustrated in FIG. 1, a user 30 at each of workstations 28-1 and 28-2 has accessed items 35-1 and 35-2 respectively. A user 30 may select any of a number of types of item 35. The item 35 may be a set report comprising a tabulation of the non-negative matrix factorization of a set 2 of documents and displaying semantic topics, an individual document 1, a form for an operation further described below or any other information accessible by the workstation 28. The items 35-1 and 35-2 may be the same or different items. If they are the same, the respective users 30 may perform different operations with respect to the same set item 35.

These operations include constructing queries by assigning weights to semantic topics. A user 30 may assign weights to semantic topics within a set to affect the ordering of documents 1 in a set 2 by their relevance. Further refinement of weighting may be accomplished by having users 30 provide feedback based on their judgment of the efficacy of established queries in capturing information of interest. Users 30 may provide feedback to effectively modify the weights of a query. Users 30 may also use their experience in review of items 35 in order to define new sets of words or other indicia to define semantic topics. Searching is accomplished by scoring the semantic topics rather than by key word searching. In further embodiments, key word searching could augment semantic topic analysis.

As further documents are added to a set 2, W may be updated by recalculating the W*H factorization. In one preferred from, W is frequently and regularly recalculated. W may also be “downdated.” Information may be removed from sets of data in order to speed processing time. If it is noted that semantic factors contributing to hits in particular semantic topics are no longer appearing in new documents, a new set 2 may be created in which the words of the factor are removed from the set 2.

The method and apparatus may maintain a plurality of analytical factors for each document 1 or set 2. Documents 1 may each be included in one or more sets 2. Each set 2 may be analyzed according to different groups of semantic topics. One or more users 30 may assign different groups of weights for the same set 2. Updated, downdated and unchanged matrix factorizations may be maintained for each set 2.

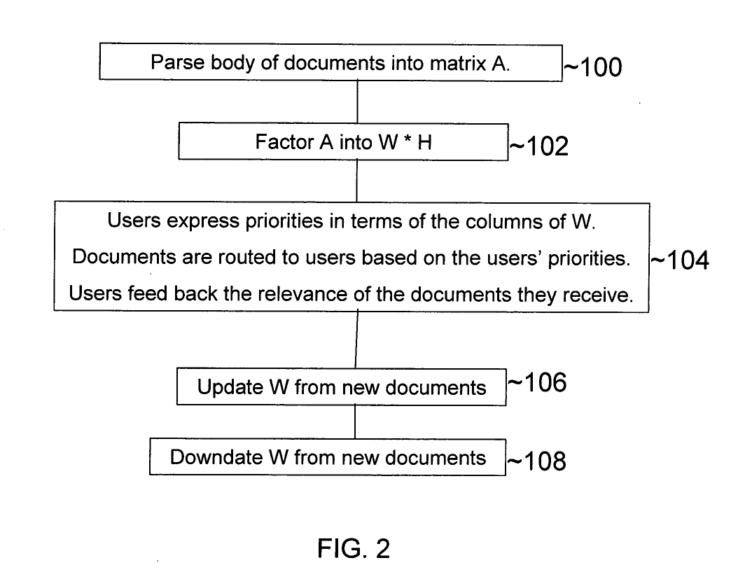

FIG. 2 is a flow chart illustrating operation of embodiments of the present invention. The procedure begins with taking a body of unprocessed documents 1. In step 100, the documents 1 are parsed into a term-document matrix. The matrix has the form A, i.e. aᵢⱼ, where the value of a matrix entry is a function of the number of times term i appears in document j. At step 102, A is factored into a product W*H using non-negative matrix factorization. For example, an iterative algorithm taught by Seung and Lee, supra, may be used to perform the non-negative matrix factorization.

W and H are each a reduced-dimensional matrix. Each column of W is a basis vector. The columns of W contain encodings of the semantic topics contained in the body of documents. Each column of W is a basis vector, i.e., it contains an encoding of a semantic space or topic from A. Each column of H contains an encoding of the linear combination of the basis vectors that approximates the corresponding column of A. Each semantic topic is expressed as a combination of terms that appear together in a set 2 of documents 1 (FIG. 1). This representation is much more robust than keyword indexing. With semantic indexing, a document containing only the word “explosive” can be caught by a query on the word “bomb” if some documents in the body contain both “bomb” and “explosive.” This is done by including both bomb and explosive in the definition of a semantic topic.

Semantic indexing reduces a body of thousands of documents to a few hundred groups of words. Visual inspection of the groups reveals the contents of the full body of documents. Documents corresponding to the most urgent topics can be read immediately, with others following, according to the importance of their topics as revealed by the factorization, until the entire backlog is processed.

In step 104, users 30 express their current priorities in terms of the semantic topics of W by providing weights for each semantic topic in order to query information from the documents under consideration. For example, “explosives” could be assigned a higher weight than “history.” Each document in the body of documents that generated the matrix A is evaluated against the users' 30 queries, and routed to the users 30 expressing interest in the semantic topics of the document. As new documents arrive, the documents 1 are parsed, evaluated against the users' 30 queries, and routed to the users 30 expressing interest in the semantic topics of the new document. As documents are processed, users' feedback on the relevance of each new document is incorporated into the queries. Users 30 may perform an iterative process to determine desired weights to be given to semantic topics.

Any document that does not match well with any topic goes into a general category to be processed by general users. These documents should not be ignored. They may contain new topics or important topics expressed in unusual ways.

At step 106, updating of W may be performed. New documents 1 may be added to the body comprising a set 2, and the W*H factorization is recalculated. If this is too time consuming for an urgent analysis requirement, there are less demanding techniques for “folding in” new documents. For example, a user 30 could provide an input to force a new value for W. Rigorous updating of the matrix by recalculation may be done later. Regardless of the method chosen, step 106, updating W, is preferably carried out on a frequent, regular schedule.

Step 108, downdating W, i.e. dropping semantic factors that are no longer appearing in new documents, may follow step 104 or may follow step 106. It is not essential to perform both steps 104 and 106, although it is preferable. Step 108 is shown following step 106 to illustrate one embodiment. This illustration, however, does not limit the order or selection of steps. A semantic factor is one or more members of a semantic topic. Once such a semantic factor is identified, the documents 1 that contributed the word(s) of the semantic factor are removed from documents 1 in the set 2 that generated W.

Different sets 2 may be constructed from or different semantic topics may be applied to documents 1. Various values for W may be created, each yielding a different analysis of documents 1. Different sets 2 of documents 1 can be used to generate different factorizations, each of which can be used on all incoming documents 1. One body of documents can also generate more than one factorization if different levels of detail, called the rank of the factorization, are chosen. The system could report that a document was judged relevant by more than one factorization and guarantee that the user sees just one copy.

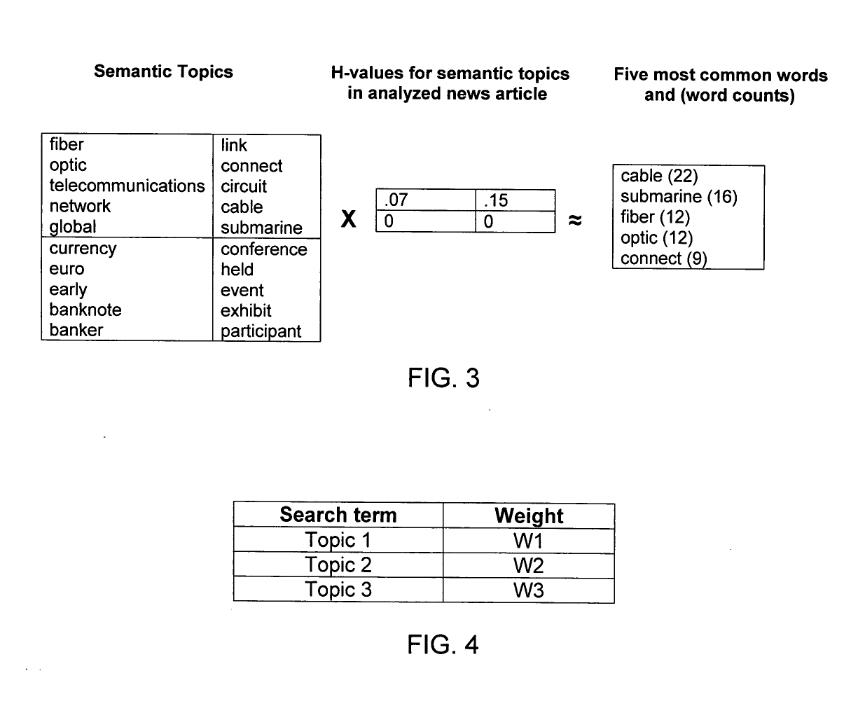

FIG. 3 is a diagram illustrating an instance of non-negative matrix factorization performed on documents that were newly downloaded. Non-negative matrix factorization was used to discover semantic features in a set of news articles downloaded from Factiva (www.factiva.com). The matrix A takes the form A=m×n, where m is the number of different terms in a dictionary which will recognize words, and n is the number of documents downloaded. A dictionary was used having a vocabulary of m=34,665. In this illustration, n, the number of documents, is 5,650. For each term in the vocabulary, a term weight, based upon the number of occurrences of the term, was calculated in each document and used to form the 34,665×5,650 matrix A. Each column of A contained the term weights for a particular article, whereas each row of A contained the weights of a particular term in different articles. The matrix was approximately factorized into the form W*H using the above-cited algorithm of Lee and Seung. A set of semantic topics (columns of W) was constructed. The left portion of FIG. 3 illustrates four of the semantic topics. Each topic is represented by a list of the five words with the highest term weights in that topic. The five words are listed in order of term weight within the topic. Right, the five most frequent words and their counts in a news article on the announcement of plans to lay an underwater fiber optic cable linking Iran and Kuwait. The middle table shows the H-values for the news article corresponding to the four topics. High weight is given to the upper two semantic topics, and no weight to the lower two.

Construction of a query is illustrated in FIG. 4. Topics are selected, and each topic is given a weight. In the present illustration, a user has selected topic1 with a weight of w1, topic2 with a weight of w2, and topic3 with a weight of w3. To perform a query using weighted query terms, a user must submit the semantic topics (columns of W) of interest, along with a measure of each topic's importance, say on a scale from 1 to 10.

In order to execute the query, the following steps are performed:
1. Normalize the weights by dividing each weight by \sqrt{w1²+w2²+w3²}
2. Construct a query vector with components equal to the normalized weights in the dimensions corresponding to topic1, topic2, and topic3, and equal to 0 elsewhere.
3. Compute the similarity between the query vector and each column of H.
4. Sort the columns of H in decreasing order of similarity to the query vector.
5. Return the corresponding documents to the user in the same decreasing order of similarity.

A machine-readable medium may also be produced to operate the apparatus of FIG. 1 or other apparatus to provide the above-described document analysis. The machine-readable medium is a program with instructions to cause performance of the above-described steps. A machine-readable medium includes any mechanism that provides (i.e., stores and/or transmits) information in a form readable by a machine (e.g. a computer). For example, a machine-readable medium includes read only memory (ROM); random access memory (RAM); magnetic disk storage media; flash memory devices; electrical, optical, acoustical or other form of propagated signals (e.g., carrier waves, infrared signals, etc.); etc.

Many different routines suggested by the above teachings may be automated or performed manually to analyze documents and provide for dynamic adjustment of the input information on which analysis is based. Reporting of information, access of documents and selection of extracts from documents may also be performed.

Embodiments of the present invention provide for analysis of documents providing the ability to refine relevance criteria and to update and downdate a body of documents serving as input information. The present subject matter being thus described, it will be apparent that the same may be modified or varied in many ways. Such modifications and variations are not to be regarded as a departure from the spirit and scope of the present subject matter, and all such modifications are intended to be included within the scope of the following claims.

What is claimed is:

1. A method of evaluating a body of documents, comprising:
parsing the body of documents into a term-document matrix A of values aᵢⱼ, where aᵢⱼ=a function of the number of times the term i appears in document j;
factoring the matrix A into a product W*H using non-negative matrix factorization, where W represents semantic topics contained in the body of documents and wherein each column of H contains an encoding of a linear combination of the semantic topics that approximates a corresponding column of A; and
constructing queries by weighting semantic topics to order the documents in accordance with relevance to the queries.

2. A method according to claim 1, further comprising updating W in accordance with contents of successive documents.

3. A method according to claim 2, further comprising evaluating each body of documents in accordance with each of a plurality of sets of W.

4. A method according to claim 3, further comprising providing at least one input to refine values in a query in accordance with a user's evaluation of the efficacy of the evaluation of the body of documents against the query.

5. A method according to claim 4, further comprising flagging a document having all coefficients of its linear combination of the W-basis vectors below a preselected level.

6. A method according to claim 4, further comprising downdating W to drop semantic factors no longer appearing in new documents.

7. A method according to claim 4, further comprising generating a plurality of sets of W and evaluating a body of documents using each set of W.

8. A method according to claim 7, further comprising providing reports showing results for a body of documents for each of a plurality of sets of W.

9. A machine-readable medium that provides instructions, which when executed by a processor, causes said processor to perform operations comprising:
parsing a body of documents into a term-document matrix A of values aᵢⱼ, where aᵢⱼ=a function of the number of times the term i appears in document j;
factoring the matrix A into a product W*H using non-negative matrix factorization, where W represents semantic topics contained in the body of documents and wherein each column of H contains an encoding of a linear combination of the semantic topics that approximates a corresponding column of A; and
constructing queries by weighting semantic topics to order the documents in accordance with relevance to the queries.

10. A machine-readable medium according to claim 9, further comprising instructions for updating W in accordance with contents of successive documents.

11. A machine-readable medium, according to claim 10, further comprising instructions for evaluating each body of documents in accordance with each of a plurality of sets of W.

12. A machine-readable medium, according to claim 11, further comprising instructions responding to providing at least one input to refine values in a query in accordance with a user's evaluation of the efficacy of the evaluation of the body of documents against the query.

13. A machine-readable medium, according to claim 12, further comprising instructions for flagging a document having all coefficients of its linear combination of the W-basis vectors below a preselected level.

14. A machine-readable medium, according to claim 12, further comprising instructions responding to an input for downdating W to drop semantic factors no longer appearing in new documents.

15. A machine-readable medium, according to claim 12, further comprising instructions generating a plurality of sets of W and evaluating a body of documents using each set of W.

16. A machine-readable medium, according to claim 15, further comprising instructions providing reports showing results for a body of documents for each of a plurality of sets of W.

17. A system to evaluate a body of documents, comprising:
a reader and processor parsing the body of documents into a term-document matrix A of values aᵢⱼ, where aᵢⱼ=a function of the number of times the term i appears in document j;
said processor factoring the matrix A into a product W*H using non-negative matrix factorization, where W represents semantic topics contained in the body of documents and wherein each column of H contains an encoding of a linear combination of the semantic topics that approximates a corresponding column of A; and
said processor constructing queries by weighting semantic topics to order the documents in accordance with relevance to the queries.

18. A system according to claim 17, further comprising means for updating W in accordance with contents of successive documents.

19. A system according to claim 18, further comprising means for evaluating each body of documents in accordance with each of a plurality of sets of W.

20. A system according to claim 19, further comprising means for providing at least one input to refine values in a query in accordance with a user's evaluation of the efficacy of the evaluation the body of documents against the query.

21. A system according to claim 20, further comprising means for flagging a document having all coefficients of its linear combination of the W-basis vectors below a preselected level.

22. A system according to claim 20, further comprising means for downdating W to drop semantic factors no longer appearing in new documents.

23. A system according to claim 20, further comprising means for generating a plurality of sets of W and evaluating a body of documents using each set of W.

24. A system according to claim 23, further comprising means for providing reports showing results for a body of documents for each of a plurality of sets of W.
